(19) United States
(12) Patent Application Publication
(10) Pub. No.: US 2006/0096587 A1
(43) Pub. Date: May 11, 2006

(54) Comestibles containing isomaltulose and trehalose for sustained carbohydrate energy release and reduced glycemic/insulinemic responses, and for preserving osmolality

(75) Inventors: Fredericus Johannes Petrus Henricus Brouns, Sibbe-Valkenburg (NL); Jacques Georges Denis Cenere Simon, Clamart (FR); Didier Charles Robert Bonnet, Uccle (BE); Jozef Guido Rosa Vanhemelrijck, Meise (BE)

Correspondence Address: FITCH, EVEN, TABIN & FLANNERY, P. O. BOX 65973, WASHINGTON, DC, 20035, US

(73) Assignee: Cerestar Holding B.V., La Sas van Gent (NL)

(21) Appl. No.: 10/550,555

(22) PCT Filed: Mar. 23, 2004
(86) PCT No.: PCT/EP04/03064

§ 371 Date: Oct. 25, 2005

(30) Foreign Application Priority Data
Mar. 24, 2003 (EP) 03251833.4
Jul. 23, 2003 (EP) 03254635.0

(51) Int. Cl. C13F 3/00; C13K 5/00

(52) U.S. Cl. 127/29; 536/123.13

(57) ABSTRACT

The current invention relates to a composition comprising isomaltulose and trehalose, and optionally at least one intense sweetener and/or a carbohydrate selected from the group consisting of fructose, sucrose, invert sugar, polyol and mixtures thereof. This composition is applied in solid, semi-solid and liquid comestibles and said composition preserves the osmolality of beverages.

### TECHNICAL FIELD

The present invention relates to a composition of isomaltulose and trehalose and optionally a carbohydrate selected from the group consisting of fructose, sucrose, invert sugar, and mixtures thereof for sustained carbohydrate energy release in edible comestibles and for preserving the osmolality.

### BACKGROUND OF THE INVENTION

There are a number of liquid, semi-solid and solid products currently applied for providing energy to the body.

A lot of liquid compositions or diluted mixtures are on the market by the name of ‘Activity drinks’, ‘Sports drinks’, ‘Energy drinks’ or ‘Nutrient drinks’. These drinks are reported to meet requirements with respect to the use and/or loss of carbohydrates, electrolytes, vitamins, electrolytes, amino acids, and other important nutrients which occurs during heavy exercise.

JP01-060360A relates to an isotonic drink which is containing palatinose (=isomaltulose) as main carbohydrates.

JP63-112963A relates to food and drink which is containing palatinose as a sweetener, and/or excipient, and/or extender.

Kawai in Hormone and Metabolic Research, Vol 21, No 6, 24 Feb. 1989, page 338-340 describes the usefulness of palatinose as caloric sweetener for diabetic patents.

JP 63 112963 (Abstract) relates to drink and food containing palatinose and particular useful for patients suffering from diabetes.

JP 01 060360 (Abstract) relates to a sports drink containing palatinose for supplying energy.

WO 03/022288 relates to nutritional compositions containing palatinose for controlling blood glucose and preventing obesity.

EP 0 882 408 relates to a method for improving the aftertaste of sucrose without lowering the sweetening power of sucrose, and which comprises incorporating trehalose in an amount of 2 to 12% to the sucrose.

JP2001069941A2 (Abstract) relates to a composition which retains a sugar-like flavor by coexistence of fructose and trehalose in a ratio of 1:(0.4 to 1).

JP2000262216A2 (Abstract) relates to a sweetener containing coffee beverage comprising trehalose in an amount corresponding to 10-30% of the sweetener.

JP9173017A2 (Abstract) relates to a beverage or food containing trehalose for improvement of physical strength.

GB 2 353 934 relates to nutritional compositions comprising trehalose for persons suffering from diabetes.

GB 2 356 788 relates to the use of trehalose for the preparation of a nutritional composition for oral administration to a subject during or shortly before physical exercise to maintain the blood glucose level of a subject for a sustained period during and after said exercise.

Jentjens in Eur. J. Appl. Physiol. (2003) Vol. 88, pages 459-465 describes the effect of pre-exercise ingestion of trehalose.

There is a further need for having compositions suitable for sustained carbohydrate energy release and which are at the same time suitable for preserving the osmolality of beverages and improve the storage stability.

The current invention provides such a composition and products comprising this composition.

### SUMMARY OF INVENTION

The current invention relates to a dry composition comprising isomaltulose and trehalose. In a preferred embodiment such a composition is comprising isomaltulose and trehalose in a weight ratio from 10:90 to 90:10. It further relates to a composition which is comprising further at least an intense sweetener.

The current invention further relates to a dry composition comprising isomaltulose and trehalose and a carbohydrate (A) selected from the group consisting of fructose, sucrose, invert sugar, polyol and mixtures thereof.

The current invention relates to a liquid blend comprising a liquid and the dry composition as previously described. Said liquid blend can further comprise a carbohydrate (B) selected from the group consisting of fructose, fructose syrups, sucrose, invert sugar, polyol and mixtures thereof.

Furthermore, the current invention relates to a solid or semi-solid comestible characterized in that said comestible is comprising edible ingredients and at least 5% of the dry substance of said comestible is the dry composition of the current invention.
The current invention further relates to a liquid comestible comprising:
a) Edible ingredients and the liquid blend previously described and optionally a liquid, or b) a liquid and the solid, semi-solid comestible earlier described.

Comestibles of the current invention are selected from the group consisting of tablets, bars, confectionery, beverages, beverage concentrates, gels, drink powders, diabetic food, baby food, infant food, dietetic food, slimming food, food for special dietary needs and medical food.

Furthermore, the current invention relates to a beverage selected from the group consisting of hypotonic beverages, soft drinks, sports drinks, hypertonic beverages, energy drinks and isotonic beverages. The beverage can comprise further carbohydrates (C), proteins, peptides, amino acids, antioxidants, fats, vitamins, trace elements, electrolytes, intense sweeteners, edible acids, flavors and/or mixtures thereof. These further carbohydrates (C) are selected from the group consisting of monosaccharides, disaccharides, gelling starches, starch hydrolysates, dextrins, fibers, polyols and mixtures thereof.

At least 50% of the dry substance of said beverage is a dry composition comprising
a) isomaltulose and trehalose, or
b) isomaltulose, trehalose, and at least one intense sweetener and/or a carbohydrate
   (A) selected from the group consisting of fructose, sucrose, invert sugar, polyol and mixtures thereof.

It further relates to a beverage wherein at least 80%, preferably at least 90% more preferably at least 95% of the dry substance of said beverage is a dry composition comprising
a) isomaltulose and trehalose, or
b) isomaltulose, trehalose, and at least one intense sweetener and/or a carbohydrate
   (A) selected from the group consisting of fructose, sucrose, invert sugar, polyol and mixtures thereof.

The current invention further relates to an isotonic beverage that is comprising isomaltulose, trehalose and sucrose wherein the weight ratio of isomaltulose, trehalose to sucrose is from 30:70 to 90:10, preferably from 30:70 to 80:20. Furthermore, said isotonic beverage can comprise at least one intense sweetener, isomaltulose, trehalose and sucrose wherein the weight isomaltulose, trehalose to sucrose is from 30:70 to 90:10, preferably from 30:70 to 50:50, more preferably from 30:70 to 40:60. In a further specification, said isotonic beverage is comprising a polyol or a mixture of polyols.

Furthermore, the current invention relates to a method of preserving osmolality of a beverage, preferably an isotonic beverage, by replacing 20 to 90%, preferably 30 to 80% by weight of sucrose with trehalose and isomaltulose. At least one intense sweetener and/or polyol or mixture of polyols can be added.

The current invention further relates to a method wherein the osmolality is preserved for at least one month at ambient temperature, preferably for at least 3 months.

Furthermore, the current invention relates to the use of a composition comprising isomaltulose and trehalose. Specifically, it relates to the use of trehalose and isomaltulose for preserving the osmolality of beverages selected from the group consisting of hypotonic beverages, soft drinks, sports drinks, hypertonic beverages, energy drinks, and isotonic beverages. In addition, it relates to the use of trehalose and isomaltulose to increase the storage stability of beverages, preferably isotonic beverages.

### DESCRIPTION OF THE FIGURES

FIG. 1: Typical curve for glucose response in blood of a mixture of isomaltulose and trehalose in a weight ratio of 50:50, compared to glucose response for glucose in blood.

FIG. 2: Typical curve for insulin response in blood of a mixture of isomaltulose and trehalose in a weight ratio of 50:50, compared to insulin response of glucose.

### DETAILED INVENTION

The current invention relates to a dry composition comprising isomaltulose and trehalose.

Isomaltulose or 6-O-α-D-glucopyranosyl-D-fructofuranose is a carbohydrate synthesised from sucrose by the action of an enzyme present in bacterial strains like Protaminobacter rubrum, Erwinia rhapontici and Serratia plymuthica.

Trehalose (α-D-glucopyranosyl-α-D-glucopyranoside) is a non-reducing saccharide (carbohydrate) composed of two glucose units.

In one embodiment such a dry composition is comprising isomaltulose and trehalose in a weight ratio from 10:90 to 90:10, preferably 50:50. In addition the intermediate weight ratios of isomaltulose to trehalose, such as 20:80, 30:70, 40:60, 70:30, 80:20 are also part of this invention.

It further relates to a dry composition which is comprising further at least one intense sweetener. An intense sweetener, which can be used as non-nutritive sweetener can be selected from the group consisting of aspartame, acesulfame salts such as acesulfame-K, saccharins (e.g. sodium and calcium salts), cyclamates (e.g. sodium and calcium salts), sucralose, alitame, neotame, steviosides, glycyrrhizin, neohesperidin dihydrochalcone, monatin, monellin, thaumatin, brazzein and mixtures thereof.

The current invention further relates to a dry composition comprising isomaltulose and trehalose and a carbohydrate (A) selected from the group consisting of fructose, sucrose, invert sugar, polyol and mixtures thereof.

The polyol can be selected from tetritols, pentitols, hexitols, higher polyols, and the like. The polyol can be but is not limited to erythritol, xylitol, arabinitol, sorbitol, mannitol, iditol, galactitol, maltitol, isomaltitol, isomalt, lactitol, mixtures thereof and the like.

The current invention relates to a liquid blend comprising a liquid and the dry composition as previously described, i.e. the dry composition comprising isomaltulose and trehalose, the dry composition comprising isomaltulose, trehalose and at least one intense sweetener or the dry composition comprising isomaltulose, trehalose, and at least one intense sweetener and/or a carbohydrate (A) selected from the group consisting of fructose, sucrose, invert sugar, polyol and mixtures thereof. The liquid can be any edible, polar liquid, preferably a water containing liquid, more preferably water. Polar liquids are hydrophilic liquids miscible with water.

Said liquid blend can further comprise a carbohydrate (B) selected from the group consisting of fructose, fructose syrups, sucrose, invert sugar, polyol and mixtures thereof. Preferably, the carbohydrate (B) is provided in a liquid form.

Fructose syrups cover all syrups containing on dry substance from 42 to 100% fructose. An example of such a fructose syrup can be high fructose corn syrup which is containing from 42-55% fructose.

In a specific embodiment isomaltulose and trehalose is present from 30 to 90% preferably from 30 to 80% by weight of said dry composition or isomaltulose and trehalose is present in a weight amount of 30 to 90%, preferably from 30 to 80% based on dry substance of liquid blend.

The dry composition and/or liquid blend is particular applicable for providing carbohydrate energy over a long period, while the dry composition and the liquid blend is digestible, and absorbable.

Furthermore, the current invention relates to a solid or semi-solid comestible comprising edible ingredients and at least 5% of the dry substance of said comestible is a dry composition containing:
a) isomaltulose and trehalose, or,
a) isomaltulose, trehalose and at least one intense sweetener and/or a carbohydrate
   (A) selected from the group consisting of fructose, sucrose, invert sugar, polyol and mixtures thereof.

The comestible is containing any suitable edible ingredient and at least 5% of the dry substance is the dry composition of the current invention. I.e. the dry composition comprising isomaltulose and trehalose, the dry composition comprising isomaltulose, trehalose and at least one intense sweetener or the dry composition comprising isomaltulose, trehalose, and at least one intense sweetener and/or a carbohydrate (A) selected from the group consisting of fructose, sucrose, invert sugar, polyol and mixtures thereof.

The current invention further relates to a liquid comestible characterized in that is comprising
a) Edible ingredients and the liquid blend previously described and optionally a liquid, or
b) a liquid and the solid, semi-solid comestible earlier described.

For obtaining the liquid comestible the liquid blend of the current invention is applied and optional a liquid, or the dry composition of the current invention is mixed with an edible polar liquid, preferably a water containing liquid, more preferably water. Actually the mix of the dry composition, the liquid blend and optionally an edible liquid is also part of the current invention.

In a specific embodiment the dry substance of currently disclosed comestibles is containing from 30 to 90%, preferably from 30 to 80% by weight of isomaltulose and trehalose.

Preferably the solid or semi-solid comestible are characterized in that said of comestible is comprising edible ingredients and at least 10% of the dry substance of said comestible is a dry composition containing:
a) isomaltulose and trehalose, or,
b) isomaltulose, trehalose and at least one intense sweetener and/or further carbohydrate (A) selected from the group consisting of fructose, sucrose, invert sugar, polyol and mixtures thereof.

It has to be understood that 10% of the dry substance of the aforementioned comestibles is the dry composition comprising isomaltulose and trehalose, or the dry composition comprising isomaltulose, trehalose and at least one intense sweetener, or the dry composition comprising isomaltulose, trehalose, a carbohydrate (A) selected from the group consisting of fructose, sucrose, invert sugar, polyol and mixtures thereof and/or an intense sweetener.

Said solid, semi-solid or liquid comestible is selected from the group consisting of tablets, confectionery, bars, beverages, beverage concentrates, gels, drink powders, diabetics food, baby food, infant food, dietetic food, slimming food, food for special dietary needs, and medical food.

Tablets can be based solely upon the dry composition of isomaltulose and trehalose or a dry composition of isomaltulose, trehalose, and at least one intense sweetener and/or a carbohydrate (A) selected from the group consisting of fructose, sucrose, invert sugar, polyol and mixtures thereof. Lubricants such as magnesium stearate, calcium stearate, stearic acid, sucrose fatty acid esters, and/or talc and the like can be added according to needs.

The diabetic food, baby food, infant food, dietetic food, slimming food, food for special dietary needs refer respectively to any type of food suitable for diabetics, babies, infants and people needing a special dietetic formulation and any one who can benefit from the presence of a sustained carbohydrate energy release source, and those who can benefit from a modified perception of satiety or hunger.

Medical food refer to any liquid, semi-solid or liquid comestible which is given to people in medical need for having access to extra sustained carbohydrate energy source, e.g. people with heavy burns and/or scalds.

The current invention relates to a comestible selected from the group consisting of beverage concentrates, gels, drink powders, hypotonic beverages, soft drinks, sports drinks, hypertonic beverages, energy drinks, and isotonic beverages.

The current invention further relates to a beverage selected from the group consisting of hypotonic beverages, soft drinks, sports drinks, hypertonic beverages, energy drinks and isotonic beverages.

The beverage can be any medical syrup or any drinkable solution including iced tea, and fruit juices, vegetable based juices, lemonades, cordials, nut based drinks, cocoa based drinks, dairy products such as milk, whey, yogurts and drinks based on them.

Beverage concentrate refers to a concentrate that is either in liquid form or in essentially dry mixture form. The liquid concentrate can be in the form of a relatively thick, syrupy liquid. The essentially dry mixture can be in the form of either a powder or a tablet. The beverage concentrate is usually formulated to provide a drinkable beverage composition or a final beverage when constituted or diluted with water, either carbonated or non-carbonated.

Drink powders are suitable for constituting with water, carbonated or non-carbonated, a final beverage for oral administration.

A specific example of a hypotonic beverage is a rehydration drink.

In general, the beverage can further be characterized in having an osmolality of from 50 to 800 mOs/kg, preferably from 150 to 600 mOs/kg, more preferably from 200 to 400 mOs/kg.

An isotonic beverage is typically characterized by an osmolality of from 270-330 mOs/kg.

The beverage further can comprise carbohydrates (C), proteins, peptides, amino acids, antioxidants, fats, vitamins, trace elements, electrolytes, intense sweeteners, edible acids, flavors and/or mixtures thereof.

Actually beverages can be prepared wherein the complete dry substance of the carbohydrates present in the beverage is consisting of isomaltulose, trehalose or isomaltulose, trehalose and said carbohydrate (A), preferably in a weight ratio of isomaltulose, trehalose to carbohydrate (A) from 30:70 to 90:10, preferably from 30:70 to 80:20. In a more preferred embodiment, at least one intense sweetener and/or at least one polyol can be added. More preferably the carbohydrate (A) is either sucrose or fructose.

Beverages wherein the dry substance of the carbohydrates is consisting of 50% (w/w) isomaltulose, trehalose and 50% (w/w) fructose, give the same sensory perception as a standard sucrose based beverage. Actually beverages wherein the dry substance of the carbohydrates is consisting of 51% (w/w) isomaltulose, trehalose and 49% (w/w) fructose, and wherein the weight ratio of isomaltulose to trehalose is 50:50, give a good flavour perception and are comparable to a standard sucrose based beverage, according to the evaluation of a taste panel. Furthermore, it is seen that beverages wherein the dry substance of the carbohydrates 50% (w/w) isomaltulose, trehalose in a respective weight ratio of 50:50, and 50% (w/w) sucrose give good sensory perception.

The further carbohydrates (C) are selected from the group consisting of monosaccharides, disaccharides, gelling starches, starch hydrolysates, dextrins, fibers, polyols and mixtures thereof, whereby these carbohydrates are different from isomaltulose, trehalose and carbohydrate (A) and (13) as mentioned in the composition of current invention.

The monosaccharides include tetroses, pentoses, hexoses and ketohexoses.

Typical disaccharides include sucrose, maltose, trehalulose, melibiose, kojibiose, sophorose, laminaribiose, isomaltose, gentiobiose, cellobiose, mannobiose, lactose, leucrose, maltulose, turanose and the like.

Starch hydrolysates are produced by the controlled acid or enzymatic hydrolysis of starch and can be subdivided into two specific categories, maltodextrins and glucose syrups and are characterized by DE number (dextrose equivalent). In fact, DE number is a measurement of the percentage of reducing sugars present in the syrup and calculated as dextrose on a dry weight basis. Maltodextrins have a DE number up to 20 whereas glucose syrups have an DE number greater than 20.

Dextrins are prepared according to the dextrinisation method. Dextrinisation is a heat treatment of dry starch in presence or absence of acid.

Gelly starches may include emulsified starches such as starch n-octenyl succinate.

The low-calorie fibers can be polydextrose, arabinogalactan, chitosan, chitin, xanthan, pectin, cellulosics, konjac, gum Arabic, soy fiber, inulin, modified starch, hydrolysed guar, guar gum, beta-glucan, carageenan, locust bean gum, alginate, polyglycol alginate.

At least 50% of the dry substance of said beverage is comprising a dry composition containing
a) isomaltulose and trehalose, or
b) isomaltulose, trehalose, and at least one intense sweetener and/or a carbohydrate
   (A) selected from the group consisting of fructose, sucrose, invert sugar, polyol and mixtures thereof.

It further relates to a beverage wherein at least 80%, preferably at least 90%, more preferably at least 95% of the dry substance of said beverage is a dry composition containing
a) isomaltulose and trehalose, or
b) isomaltulose, trehalose, and at least one intense sweetener and/or a carbohydrate
   (A) selected from the group consisting of fructose, sucrose, invert sugar, polyol and mixtures thereof.

Among the major physiological electrolytes are sodium, potassium, chloride, calcium, and magnesium. Further trace elements can be included such as chromium, copper, selenium, iron, manganese, molybdenym, zinc and mixtures thereof.

Among the vitamins one can range vitamin A, vitamin C, vitamin E, vitamin B₁₂, and the like.

The edible acids can be selected from phosphoric acid, citric acid, malic acid, succinic acid, adipic acid, gluconic acid, tartaric acid, fumaric acid and mixtures thereof. Preferably the pH range of the beverage is from about 2 to about 6.5.

The flavors are selected from fruit flavors, botanical flavors and mixtures thereof. Preferred flavors are cola flavor, grape flavor, cherry flavor, apple flavor and citrus flavors such as orange flavor, lemon flavor, lime flavor, fruit punch and mixtures thereof. The amount of flavor depends upon the flavor or flavors selected, the flavor impression desired and the form of flavor used.

If desired, coloring agents can also be added. Any water-soluble coloring agent approved for food use can be utilized for the current invention.

When desired, preservatives such as potassium sorbate and sodium benzoate can be added.

Gums, emulsifiers and oils can also be added in the beverage for texture and opacity purposes. Typical ingredients include carboxymethylcellulose, mono-di-glycerides, lecithin, pulp, cotton seed oil and vegetable oil. It further can comprise foam stabilizing agents such as yucca, or yucca/quillaia extracts.

The beverage may be prepared by mixing together all of the ingredients. The mixture is then dissolved in water and agitated until all the ingredients are dissolved. Dissolution may occur at ambient temperature but it may be necessary for the solution to be heated to temperature between 50-100° C. to get all the ingredients into solution. After the mixture having been adjusted to a desired pH, the beverage may be bottled, capped, and eventually pasteurized at about 75° C. for about 20 minutes, or the beverage may be before bottling continuously pasteurized for a few minutes.

One way to prepare the concentrate of the beverage would be to start with less than the required volume of the liquid solvent that is used to prepare the drinkable beverage. Another way would be to partially dehydrate the finally prepared drinkable beverage to remove only a portion of the liquid solvent and any other volatile liquid present.

Carbon dioxide can be introduced either into the water to be mixed with the beverage concentrate or into the drinkable beverage to achieve carbonation. The carbonated beverage can then be stored in a container, such as a bottle or a can, and is then sealed.

The current invention further relates to an isotonic beverage that is comprising isomaltulose, trehalose and sucrose wherein the weight ratio of isomaltulose, trehalose to sucrose is from 30:70 to 90:10, preferably from 30:70 to 80:20. Furthermore, said isotonic beverage can comprise at least one intense sweetener, isomaltulose, trehalose and sucrose wherein the weight isomaltulose, trehalose to sucrose is from 30:70 to 90:10, preferably from 30:70 to 50:50, more preferably from 30:70 to 40:60. In a further specification, said isotonic beverage is comprising at least one intense sweetener and/or a polyol or a mixture of polyols.

Furthermore, the current invention relates to a method of preserving (sustaining) the osmolality of a beverage, preferably an isotonic beverage, by replacing 20 to 90%, preferably 30 to 80%, by weight of sucrose with trehalose and isomaltulose. At least one intense sweetener and/or polyol or mixture of polyols can be added.

Osmolality is a count of the total number of osmotically active particles in a solution and is equal to the sum of the molalities (molality is the number of particles in a mass weight of fluid (mmol/kg)) of all the solutes present in that solution.

In an isotonic beverage the concentration of the carbohydrates is such that the osmolality (expressed in mOs/kg) is the same or is only marginally exceeding the tonicity (=measure of the osmotic pressure of a solution relative to the osmotic pressure of the blood fluids) of the blood. The osmolality of blood usually ranges from about 280 to 310 mOs/kg. The osmolality can be measured with an osmometer, which is a device measuring the osmotic pressure (for example measuring the osmolality by the freezing-point method).

The method of the current invention is particular useful for beverages at pH below 7, preferably at pH between 3 and 4, more preferably for beverages at pH between 2 and 3.

Surprisingly, it was found that by replacing sucrose completely or partially with a composition comprising isomaltulose and trehalose in a beverage, preferably an isotonic beverage, the osmolality is constant under acid conditions and the osmolality remains over time more constant then in isotonic beverages based upon sucrose as carbohydrate source. Actually due to the more stable osmolality, a higher amount of the composition comprising isomaltulose and trehalose can be added to the beverage and yet the tonicity is not increasing at acidic pH, and consequently a higher amount of energy can be provided, over a longer period.

Actually, the current invention relates to a method wherein the osmolality is preserved for at least one month at ambient temperature, preferably for at least 3 months.

Furthermore, the current invention relates to the use of a composition comprising isomaltulose and trehalose, or to the use of compositions comprising isomaltulose and trehalose and which is further comprising at least one intense sweetener and/or a carbohydrate (A) selected from the group consisting of fructose, sucrose, invert sugar, polyol and mixtures thereof.

More specifically, it relates to the use of trehalose and isomaltulose for preserving the osmolality of beverages selected from the group consisting of hypotonic beverages, soft drinks, sports drinks, hypertonic beverages, energy drinks, and isotonic beverages. In addition, it relates to the use of trehalose and isomaltulose to increase the storage stability of isotonic beverages.

The current invention has the following advantages:
The composition comprising isomaltulose and trehalose is a suitable source of sustained carbohydrate energy release.
The composition comprising isomaltulose and trehalose and at least one intense sweetener and/or a carbohydrate (A) selected from the group consisting of fructose, sucrose, invert sugar, polyol and mixtures thereof, is particularly useful as a source of sustained carbohydrate energy release.
Said composition is digestible, and absorbable.
The composition is versatile applicable in solid, semi-solid and liquid comestibles.
The comestible is suitable for athletics, diabetics, babies, infants, elderly people and those requiring a special diet.
The comestible is suitable for people following a slimming diet due to the modified perception of satiety or hunger.
Osmolality of beverages is very stable due to the addition of isomaltulose and trehalose.
The composition comprising isomaltulose and trehalose is particular suitable for preparing beverages, preferably isotonic beverages.
The composition comprising isomaltulose and trehalose improves the storage stability (constancy of tonicity).

The current invention is illustrated by way of the following examples.

### EXAMPLE 1

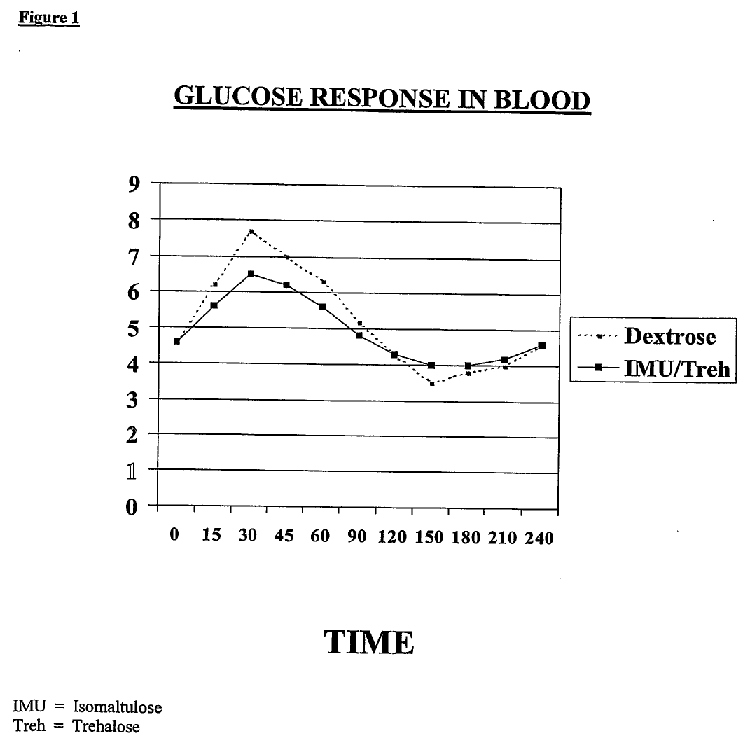

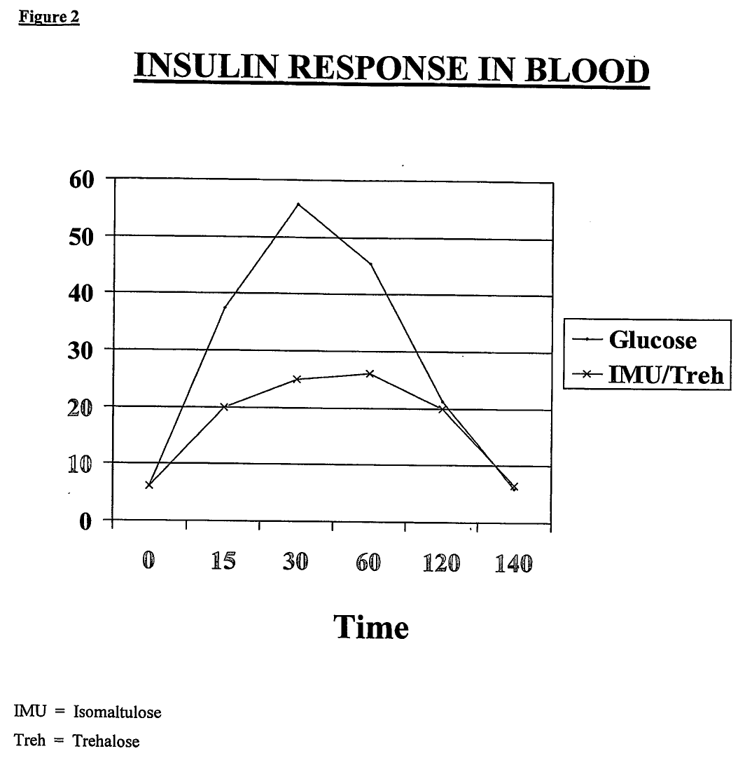

The basic syrup was prepared with the following ingredients:
152 g isomaltulose
160 g trehalose dihydrate
291 g fructose
5 ml sodium benzoate 10% (w/v)
3 ml phosphoric acid 85%
15 g cola flavor Wild (nr 35103000170000)
carbonated water (Spa™) was added for obtaining 1 liter basic syrup.
   42 ml of this basic syrup was placed in a bottle and further diluted with carbonated water to a final volume of 210 ml.
   The taste was evaluated with a taste panel, with 10 to 12 people and they were asked in a blind sampling, to evaluate the sensory quality of the isomaltulose, trehalose containing drink and compare it with the standard, being a drink based upon 100% sucrose.
   A good cola perception was found, comparable to the standard drink.
   The osmolality can be measured after 1 and 3 months storage and the value of the osmolality is not changing over time.
   The glucose and insulin response of mixtures comprising isomaltulose and trehalose in a ratio of 50:50 are displayed in FIGS. 1 and 2.

### EXAMPLE 2

The basic syrup was prepared with the following ingredients:

151 g isomaltulose
159 g trehalose dihydrate
301 g sucrose
5 ml sodium benzoate 10% (w/v)
3 ml phosphoric acid 85%
15 g cola flavor Wild (nr 35103000170000)
carbonated water (Spa™) was added for obtaining 1 liter basic syrup.
   42 ml of this basic syrup was placed in a bottle and further diluted with carbonated water to a final volume of 210 ml.
   The taste was evaluated with a taste panel with 10 to 12 people and they were asked in a blind sampling; to evaluate the sensory quality of the isomaltulose containing drink and compare it with the standard, being a drink based upon 100% sucrose.
   A good cola perception was found, comparable to the standard drink.
   The osmolality can be measured after 1 and 3 months storage and the value of the osmolality is not changing over time.

1. A dry composition comprising isomaltulose and trehalose.

2. A composition according to claim 1 characterized in that the weight ratio of isomaltulose to trehalose is from 10:90 to 90:10.

3. A composition according to claim 1, characterized in that said composition further comprises at least one intense sweetener.

4. A composition according to claim 1, characterized in that said composition comprises a further carbohydrate (A) selected from the group consisting of fructose, sucrose, invert sugar, polyol and mixtures thereof.

5. A liquid blend comprising a liquid and a dry composition according to claim 1.

6. A liquid blend according to claim 5 characterized in that said blend is comprising a further carbohydrate (B) selected from the group consisting of fructose, fructose syrups, sucrose, invert sugar, polyol and mixtures thereof.

7. A solid or semi-solid comestible characterized in that said comestible is comprising edible ingredients and at least 5% of dry substance of said comestible is a dry composition comprising:
a) isomaltulose and trehalose, or,
b) isomaltulose, trehalose and at least one intense sweetener and/or carbohydrate
(A) selected from the group consisting of fructose, sucrose, invert sugar, polyol and mixtures thereof.

8. A liquid comestible characterized in that it is comprising
a) edible ingredients and a liquid blend according to claim 5, and optionally a liquid, or
b) a liquid and a comestible according to claim 7.

9. A comestible according to claim 7, characterized in that said comestible is selected from the group consisting of tablets, bars, confectionery, beverages, beverage concentrates, gels, drink powders, diabetic food, baby food, infant food, dietetic food, slimming food, food for special dietary needs, and medical food.

10. A beverage according to claim 9 characterized in that said beverage is selected from the group consisting of hypotonic beverages, soft drinks, sports drinks, hypertonic beverages, energy drinks, and isotonic beverages.

11. A beverage according to claim 10 characterized in that it is comprising further carbohydrates, proteins, peptides, amino acids, antioxidants, fats, vitamins, trace elements, electrolytes, intense sweeteners, edible acids, flavors and/or mixtures thereof.

12. A beverage according to claim 11 characterized in that said further carbohydrates are selected from the group consisting of monosaccharides, disaccharides, gelling starches, starch hydrolysates, dextrins, fibers, polyols and mixtures thereof.

13. A beverage according to claim 10, characterized in that at least 50% of the dry substance of said beverage is a dry composition containing:
a) isomaltulose and trehalose, or,
b) isomaltulose, trehalose, at least one intense sweetener and/or carbohydrate (A) selected from the group consisting of fructose, sucrose, invert sugar, polyol and mixtures thereof.

14. A beverage according to claim 10, characterized in that at least 80% of the dry substance of said beverage is a dry composition containing:
a) isomaltulose and trehalose, or,
b) isomaltulose, trehalose, at least one intense sweetener and/or carbohydrate (A) selected from the group consisting of fructose, sucrose, invert sugar, polyol and mixtures thereof.

15. A beverage according to claim 10, characterized in that said beverage is an isotonic beverage, said beverage comprising isomaltulose, trehalose and sucrose, and wherein the weight ratio of isomaltulose, trehalose to sucrose is from 30:70 to 90:10.

16. An isotonic beverage according to claim 15 characterized in that said beverage includes at least one intense sweetener, isomaltulose, trehalose and sucrose and the weight ratio of isomaltulose, trehalose to sucrose is from 30:70 to 90:10.

17. An isotonic beverage according to claim 15, characterized in that said beverage further comprises a polyol or a mixture of polyols.

18. A method of preserving osmolality of a beverage, preferably an isotonic beverage by replacing 20 to 90% by weight of sucrose with trehalose and isomaltulose.

19. A method according to claim 18 characterized in that at least one intense sweetener is added.

20. A method according to claim 18, characterized in that a polyol or a mixture of polyols is added.

21. A method according to claim 18, characterized in that osmolality is preserved for at least one moth at ambient temperature, preferably for at least 3 months.

22. Use of a dry composition comprising isomaltulose and trehalose.

23. Use of trehalose and isomaltulose for preserving the osmolality of beverages selected from the group consisting of hypotonic beverages, soft drinks, sports drinks, hypertonic beverages, energy drinks, and isotonic beverages.

24. Use of trehalose and isomaltulose to increase the storage stability of beverages preferably isotonic beverages.
